(19) United States
(12) Patent Application Publication
(10) Pub. No.: US 2013/0134145 A1
(43) Pub. Date: May 30, 2013

(54) Heater System of Fuel Filter

(71) Applicants: Taeyoung KIM, Gunpo-si (KR); Jongkil LIM, Hwaseong-si (KR)

(72) Inventors: Taeyoung KIM, Gunpo-si (KR); Jongkil LIM, Hwaseong-si (KR)

(73) Assignees: Kia Motors Corporation, Seoul (KR); Hyundai Motor Company, Seoul (KR)

(21) Appl. No.: 13/545,798

(22) Filed: Jul. 10, 2012

(30) Foreign Application Priority Data
Nov. 30, 2011 (KR) 10-2011-0126782

(51) Int. Cl. H05B 3/02

(52) U.S. Cl. 219/201

(57) ABSTRACT

The heater system of a fuel filter includes: a power supply unit supplying power; a lead wire unit receiving power from the power supply unit and having a plurality of branch lines to divide current of the supplied power; and a fuel filter having a plurality of internal thermo switches connected to the branch lines of the lead wire unit, respectively, and a PTC heater heated by power supplied through the internal thermo switches.

### CROSS-REFERENCE TO RELATED APPLICATIONS

The present application claims priority to Korean Patent Application Number 10-2011-0126782 filed Nov. 30, 2011, the entire contents of which application is incorporated herein for all purposes by this reference.

### BACKGROUND OF THE INVENTION

1. Field of the Invention

The present invention relates to a heater system of a fuel filter, and more particularly, to a heater system of a fuel filter, using a heater and a thermo switch.

2. Description of Related Art

A heater system 10 of a fuel filter according to the related art has a structure as illustrated in FIG. 1. In this structure, when a thermo switch 14 provided in a fuel filter 12 is turned on at a predetermined temperature or less, a PTC (Positive Temperature Coefficient) heater 16 is connected to a power source and then operates. When fuel is heated by PTC heater 16, thermo switch 14 is turned off at a predetermined temperature or more so as to stop the heating.

In heater system 10 of the fuel filter according to the related art, however, a large starting current (surge current) is generated as shown in FIG. 2, when a vehicle is started. Then, as illustrated in FIG. 3, a contact portion A may be burned out, or thermo switch 14 may be molten out.

Further, heater system 10 of the fuel filter according to the related art has a limitation in design because the mounting position and structural size of thermo switch 14 are limited. More specifically, contact portion A of thermo switch 14 cannot be increased in size, in order to improve durability and increase the heating value of the heater.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a heater system of a fuel filter, which is capable of reducing a starting current by improving the design and wiring of thermo switches, thereby increasing durability.

In an aspect of the present invention, a heater system of a fuel filter, may include a power supply unit supplying power, a lead wire unit receiving the power from the power supply unit and having a plurality of branch lines to divide current of the power from the power supply unit, and the fuel filter having a plurality of internal thermo switches connected to the branch lines of the lead wire unit, respectively, wherein the plurality of internal thermo switches is electrically-connected to a PTC (Positive Temperature Coefficient) heater heated by a power supplied through the respective internal thermo switches.

The respective internal thermo switches may have operation temperature conditions which are sequentially set in different manners.

When the number of branch lines is set to two, two internal thermo switches are provided so as to correspond to the two branch lines, one of the internal thermo switches may have an ON operation condition of 7° C.±4.5° C. and an OFF operation condition of 24° C.±3.5° C., and the other one of the internal thermo switches may have an ON operation condition of −2° C.±4.5° C. and an OFF operation condition of 5° C.±3.5° C.

The power supply unit supplies a power applied from a battery disposed in a vehicle to the lead wire unit.

The internal thermo switches are connected in parallel.

In another aspect of the present invention, a heater system of a fuel filter, may include a power supply unit supplying power, a lead wire unit receiving the power from the power supply unit and having a plurality of branch lines to divide current of the power supplied from the power supply unit and an external thermo switch installed in one of the branch lines, and the fuel filter having an internal thermo switch connected to a branch line where the external thermo switch is not installed, among the branch lines of the lead wire unit, wherein the external thermo switch and the internal thermo switch are electrically-connected to a PTC (Positive Temperature Coefficient) heater heated by a power separately supplied through the external thermo switch and the internal thermo switch.

When the number of branch lines is set to two, the external thermo switch is installed on one of the two branch lines, and the internal thermo switch is connected to the other one of the two branch lines.

The internal thermo switch may have an ON operation condition of 7° C.±4.5° C. and an OFF operation condition of 24° C.±3.5° C., and the external thermo switch may have an ON operation condition of −2° C.±4.5° C. and an OFF operation condition of 5° C.±3.5° C.

The power supply unit supplies a power applied from a battery disposed in a vehicle to the lead wire unit.

The external thermo switch and the internal thermo switch are connected in parallel.

As such, the heater system of a fuel filter according to the exemplary embodiments of the present invention divides the current supplied from the power supply unit through the lead wire unit and supplies the divided currents to the internal thermo switches. Accordingly, it is possible to reduce an excessive starting current which may occur when one thermo switch is used as in the related art. Furthermore, it is possible to prevent the melt-out of the thermo switches.

Further, the heater system of a fuel filter according to the exemplary embodiment of the present invention is operated by the plurality of internal thermo switches. Therefore, even when a problem occurs in any one internal thermo switch, the operation may be maintained by another internal thermo switch. Accordingly, the safety function may be strengthened.

In addition, in the heater system of a fuel filter according to the exemplary embodiment of the present invention, since the internal thermo switches have different operation temperature conditions, the amount of currents supplied to the PTC heater may be sequentially controlled according to the temperature. Therefore, the heating value of the PTC heater may be sequentially controlled.

Moreover, since the external thermo switch is installed in the lead wire unit, the heater system of a fuel filter according to the exemplary embodiment of the present invention may be more easily manufactured, and the manufacturing cost thereof may be reduced.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic circuit diagram of a heater system of a fuel filter according to the related art.

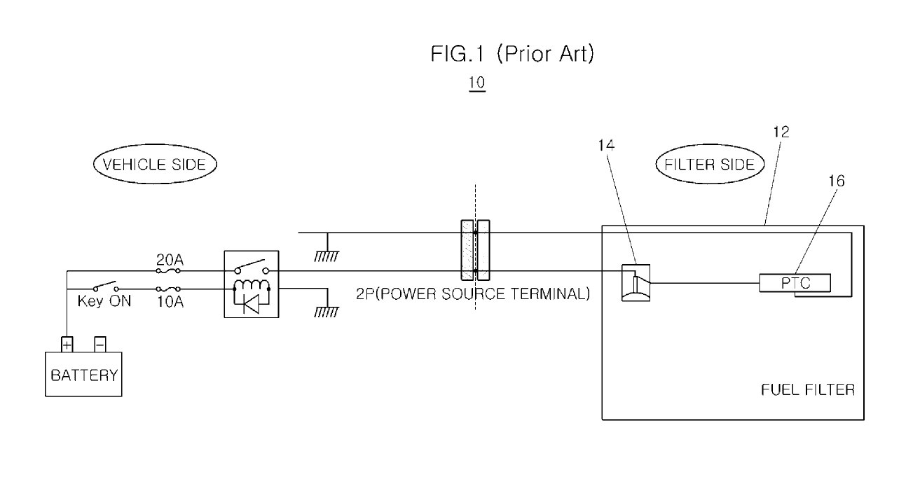

FIG. 2 is a waveform diagram of a starting current generated by a thermo switch in the heater system of a fuel filter according to the related art.

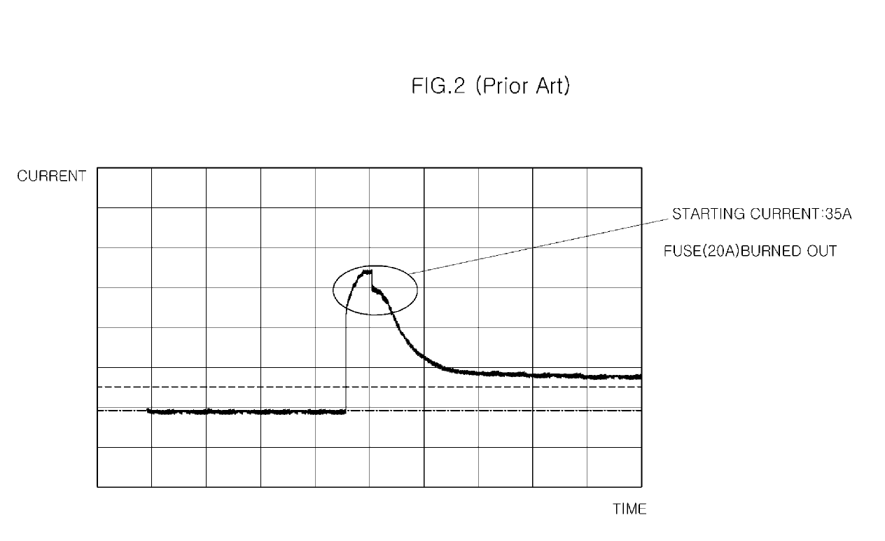

FIG. 3 is a diagram explaining damage which occurs in the thermo switch in the heater system of a fuel filter according to the related art.

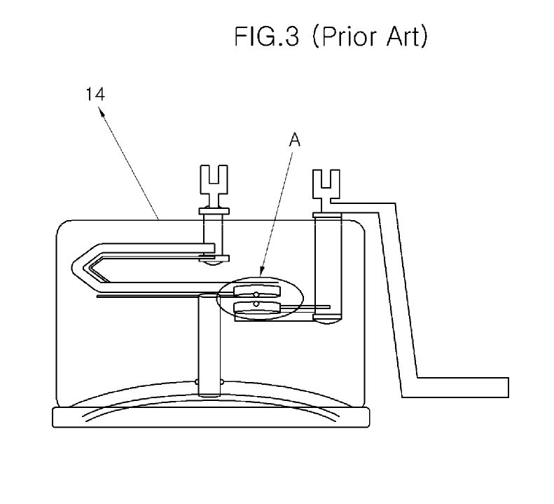

FIG. 4 is a schematic circuit diagram of a heater system of a fuel filter according to an exemplary embodiment of the present invention.

FIG. 5 is a schematic circuit diagram of a heater system of a fuel filter according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

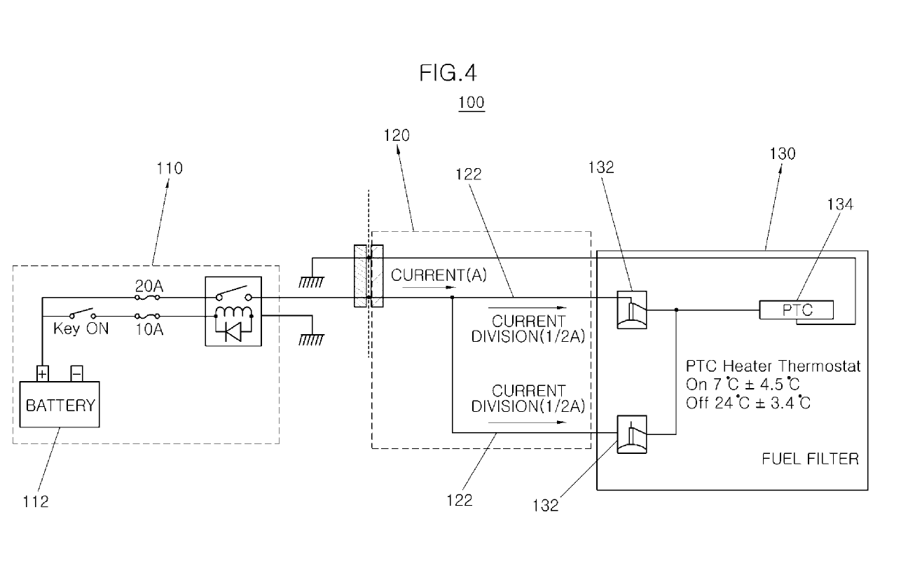

Hereinafter, a heater system of a fuel filter according to an exemplary embodiment of the present invention will be described with reference to the accompanying drawings. FIG. 4 is a schematic circuit diagram of the heater system of a fuel filter according to the exemplary embodiment of the present invention.

Referring to FIG. 4, a heater system 100 of a fuel filter according to the exemplary embodiment of the present invention may include a power supply unit 110, a lead wire unit 120, and a fuel filter 130.

Power supply unit 110 supplies power to fuel filter 130 through lead wire unit 120, using a battery 112 disposed in a vehicle as a power source.

Lead wire unit 120 may receive power from power supply unit 110, divide current of the supplied power through a plurality of branch lines, and connect the divided currents to fuel filter 130.

In FIG. 4, two branch lines 122 are provided. Accordingly, the current of the power supplied from power supply unit 110 may be divided in half and then supplied to internal thermo switches 132, respectively.

Fuel filter 130 may include a plurality of internal thermo switches 132 connected to branch lines 122 of lead wire unit 120, respectively, and a PTC heater 134 heated by the power supplied through internal thermo switches 132.

Internal thermo switches 132 may have operation temperature conditions which are sequentially set in different manners. For example, when two internal thermo switches 132 are provided as illustrated in FIG. 4, one disposed above between internal thermo switches 132 may have an ON operation condition of 7° C.±4.5° C. and an OFF operation condition of 24° C.±3.5° C., and the other one disposed below between internal thermo switches 132 may have an ON operation condition of −2° C.±4.5° C. and an OFF operation condition of 5° C.±3.5° C.

Since two internal thermo switches 132 have different OFF operation temperature conditions, two internal thermo switches 132 are turned on in time so as to supply the divided currents to PTC heater 134. Therefore, a starting current (surge current) may be lowered.

Since two internal thermo switches 132 are independently turned on/off according to the operation temperature conditions, the supply of the power through branch lines 122 of lead wire unit 120 may be selectively performed.

That is, when the one disposed above between internal thermo switches 132 is turned on and the other disposed below is turned off depending on the temperature of fuel filter 130 according to the exemplary embodiment of the present invention, the power may be supplied to PTC heater 134 only by internal thermo switch 132 disposed above.

As such, heater system 100 of a fuel filter according to the exemplary embodiment of the present invention may divide the current supplied from power supply unit 110 through lead wire unit 120, and supply the divided currents to internal thermo switches 132. Accordingly, it is possible to reduce an excessive starting current which may occur when one thermo switch is used as in the related art. Therefore, it is possible to prevent the melt-out of the thermo switches.

Heater system 100 of a fuel filter according to the exemplary embodiment of the present invention is operated by the plurality of internal thermo switches 132. Therefore, even when a problem occurs in any one internal thermo switch 132, the operation may be maintained by another internal thermo switch 132. Accordingly, the safety function may be strengthened. Internal thermo switches 132 are connected in parallel to each other.

In heater system 100 of a fuel filter according to the exemplary embodiment of the present invention, since internal thermo switches 132 have different operation temperature conditions, the amount of currents supplied to PTC heater 134 may be sequentially controlled according to the temperature. Therefore, the heating value of PTC heater 134 may be sequentially controlled.

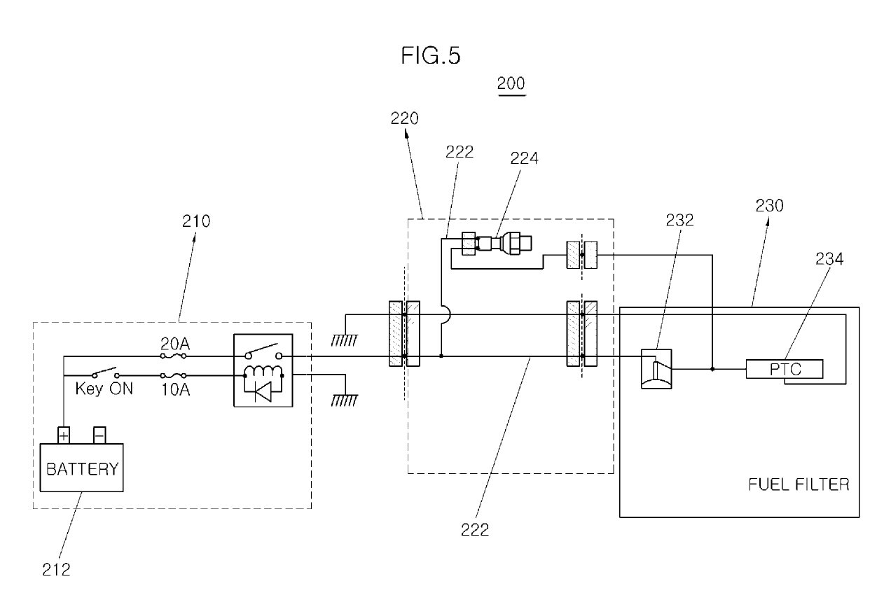

Hereinafter, a heater system 200 of a fuel filter according to another exemplary embodiment of the present invention will be described with reference to FIG. 5. In heater system 200 of a fuel filter according to the exemplary embodiment of the present invention, the current division using the parallel connection of thermo switches that is the main gist of the present invention is performed in the same manner as the above-described exemplary embodiment of the present invention. Therefore, the detailed descriptions thereof will be omitted herein.

Referring to FIG. 5, heater system 200 of a fuel filter according to the exemplary embodiment of the present invention may include a power supply unit 210, a lead wire unit 220, and a fuel filter 230 as in the above-described exemplary embodiment of the present invention.

Heater system 200 of a fuel filter according to the exemplary embodiment of the present invention is different from the heater system of a fuel filter according to the above-described exemplary embodiment of the present invention in that an external thermo switch 224 is installed on a part of branch lines 222 of lead wire unit 220. An internal thermo switch 232 disposed in fuel filter 230 is connected to branch line 222 where external thermo switch 224 is not installed, among branch lines 222 of lead wire unit 220.

As illustrated in FIG. 5, when two branch lines 222 of lead wire unit 220 are provided, external thermo switch 224 is installed on one of branch lines 222, and internal thermo switch 232 is connected to the other branch line 222.

Internal thermo switch 232 and external thermo switch 224 may have operation conditions which are sequentially set in different manners. For example, internal thermo switch 232 may have an ON operation condition of 7° C.±4.5° C. and an OFF operation condition of 24° C.±3.5° C., and external thermo switch 224 may have an ON operation condition of −2° C.±4.5° C. and an OFF operation condition of 5° C.±3.5° C.

That is, in the exemplary embodiment illustrated in FIG. 4, two internal thermo switches 132 selectively perform the current division according to the temperature. In the exemplary embodiment illustrated in FIG. 5, external thermo switch 224 and internal thermo switch 232 selectively perform the current division according to the temperature. That is, external thermo switch 224 and internal thermo switch 232 are connected in parallel.

In heater system 200 of a fuel filter according to the exemplary embodiment of the present invention, as external thermo switch 224 operating according to the temperature condition is installed in lead wire unit 220, the addition of internal thermo switch 232 to fuel filter 230 is unnecessary, unlike the above-described exemplary embodiment of the present invention. Therefore, heater system 200 according to the exemplary embodiment of the present invention may be more easily manufactured and the manufacturing cost thereof may be further reduced than in the exemplary embodiment illustrated in FIG. 4.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heater system of a fuel filter, comprising:
a power supply unit supplying power;
a lead wire unit receiving the power from the power supply unit and having a plurality of branch lines to divide current of the power from the power supply unit; and
the fuel filter having a plurality of internal thermo switches connected to the branch lines of the lead wire unit, respectively, wherein the plurality of internal thermo switches is electrically-connected to a PTC (Positive Temperature Coefficient) heater heated by a power supplied through the respective internal thermo switches.

2. The heater system as defined in claim 1, wherein the respective internal thermo switches have operation temperature conditions which are sequentially set in different manners.

3. The heater system as defined in claim 2, wherein, when the number of branch lines is set to two, two internal thermo switches are provided so as to correspond to the two branch lines, one of the internal thermo switches has an ON operation condition of 7° C.±4.5° C. and an OFF operation condition of 24° C.±3.5° C., and the other one of the internal thermo switches has an ON operation condition of −2° C.±4.5° C. and an OFF operation condition of 5° C.±3.5° C.

4. The heater system as defined in claim 1, wherein the power supply unit supplies a power applied from a battery disposed in a vehicle to the lead wire unit.

5. The heater system as defined in claim 1, wherein the internal thermo switches are connected in parallel.

6. A heater system of a fuel filter, comprising:
a power supply unit supplying power;
a lead wire unit receiving the power from the power supply unit and having a plurality of branch lines to divide current of the power supplied from the power supply unit and an external thermo switch installed in one of the branch lines; and
the fuel filter having an internal thermo switch connected to a branch line where the external thermo switch is not installed, among the branch lines of the lead wire unit, wherein the external thermo switch and the internal thermo switch are electrically-connected to a PTC (Positive Temperature Coefficient) heater heated by a power separately supplied through the external thermo switch and the internal thermo switch.

7. The heater system as defined in claim 6, wherein, when the number of branch lines is set to two, the external thermo switch is installed on one of the two branch lines, and the internal thermo switch is connected to the other one of the two branch lines.

8. The heater system as defined in claim 7, wherein the internal thermo switch has an ON operation condition of 7° C.±4.5° C. and an OFF operation condition of 24° C.±3.5° C., and the external thermo switch has an ON operation condition of −2° C.±4.5° C. and an OFF operation condition of 5° C.±3.5° C.

9. The heater system as defined in claim 6, wherein the power supply unit supplies a power applied from a battery disposed in a vehicle to the lead wire unit.

10. The heater system as defined in claim 6, wherein the external thermo switch and the internal thermo switch are connected in parallel.
